(19) United States
(12) Patent Application Publication
(10) Pub. No.: US 2025/0070843 A1
(43) Pub. Date: Feb. 27, 2025

(54) First Network Node, Second Network Node, User Equipment and Methods in a Wireless Communications Network

(71) Applicant: Telefonaktiebolaget LM Ericsson (publ), Stockholm (SE)

(72) Inventors: Christos Vranas, Stockholm (SE); Karl Werner, Segeltorp (SE); Rikke Apelfröjd, Knivsta (SE); Anders Furuskär, Stockholm (SE)

(21) Appl. No.: 18/725,894

(22) PCT Filed: Apr. 28, 2022
(86) PCT No.: PCT/SE2022/050408

§ 371 Date: Jul. 1, 2024

(30) Foreign Application Priority Data
Jan. 5, 2022 (GR) 20220100006

(51) Int. Cl. H04B 7/06; H04B 17/345; H04W 24/02

(52) U.S. Cl. CPC H04B 7/0632; H04B 17/345; H04W 24/02

(57) ABSTRACT

A method performed by a first network node for adapting a radio link to a User Equipment, UE, served by the first network node in a wireless communications network is provided. Respective channel quality measurement resources are pre-allocated for each 5 of one or more neighbouring network nodes for transmitting respective signals of one or more long-term power levels. The long-term power levels are functions of instantaneous power levels of more than one time and frequency resource of a radio link. The first network node configures (601) the UE to perform a channel quality measurement of the signals which are transmitted using the one or more long-term power 10 levels by the one or more neighbouring network nodes in the pre-allocated channel quality measurement resources. The first network node receives (602) a report from the UE. The report reports a first Channel Quality Indicator, CQI. The first CQI is calculated based on a channel quality measurement performed on the signals of the one or more long-term power levels 15 according to the configuration. The first network node then adapts (603) the radio link for a transmission to the UE based on the received first CQI.

### TECHNICAL FIELD

Embodiments herein relate to a first network node, a second network node and a User Equipment (UE) and methods therein. In some aspects, they relate to adapting a radio link to the UE served by the first network node in a wireless communications network.

### BACKGROUND

In a typical wireless communication network, wireless devices, also known as wireless communication devices, mobile stations, stations (STA) and/or User Equipments (UE)s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range, referred to as Millimeter wave (mmWave), have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques are used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

In wireless communications, Link Adaptation (LA) is used to find an appropriate modulation scheme, channel coding and rank depending on the link quality e.g., SINR. The aim of the LA is to manage to adapt to varying interference conditions and select parameters to achieve a specific Block Error Rate (BLER) and/or maximize the data rate. Furthermore, LA is often combined with Hybrid Automatic Repetition Scheme (HARQ) targeting on residual BLER performance after a set of transmission attempts that the network requirements can enable relied on the latency budget.

LA relies on estimates of the channel quality. The main components affecting the channel quality are the channel gain between transmission and reception and the interference and noise level at the receiver. The former varies over time and frequency due to fading, whereas the latter varies based on the activity of interferers and fading. The variations due to fading are rapid for high UE speed and slow for lower UE speeds. On the other hand, fluctuations due to interferers activity are on-off nature and can be very rapid regardless of the UE speed. Therefore, link quality varies rapidly over time, especially due to interferers activity. FIG. 1: depicts on-off nature of interferers activity denoted with the square curve, t on and t off.

In downlink, a base station selects the suitable modulation and coding scheme for the transmission, based on measurements of link quality from the UE. In the uplink, the channel quality is measured by the base station which then informs the UE about the transmission parameters in order to use them for coming transmissions. In both directions, these processes involve delays determined by measurement delays and reporting intervals, as well as processing delays. Thus, LA will proceed with aged link quality estimates, which may not capture the current channel and interference conditions.

Typically, since the aim is to estimate the expected link quality on the data channel, signals exposed to interference from other cells are selected.

The interference level may be estimated with Channel State Information—Interference Measurement (CSI-IM) resources. In a typical case, on a CSI-IM resource element, a serving cell wouldn't transmit anything, while neighboring cells would transmit data, if it has data scheduled. By measuring on CSI-IM resource elements, the UE may then make an estimate of the interference originating from the other cells. According to 3GPP T38.214, there are two different structures for CSI-IM, each one has four resource elements but with different mapping in terms of time and frequency. More specifically, when CSI-IM-ResourceElementPattern is set to ‘pattern0’, all the CSI-IM resource elements are at the same Orthogonal Frequency Division Multiplexing (OFDM) symbol. On the other hand, if it is set to ‘pattern1’, two resource elements are located on the same OFDM symbol and the other two on the next OFDM symbol.

FIG. 2a depicts 1×4 CSI-IM configuration (pattern0′) and FIG. 2b depicts 2×2 CSI-IM configuration (‘pattern1′).

### SUMMARY

As part of developing embodiments herein, the inventors identified a problem which first will be described.

The combination of link quality variations and aged link quality estimates means that the estimated channel quality is often inaccurate. If the estimated quality is too high, the transmission may fail. For delay-tolerant services, and/or services with relaxed residual error rate requirements, this may be acceptable, since either there is time for many transmission attempts, or it is acceptable that not all transmissions go through correctly even after retransmissions.

For delay-sensitive services, especially with more stringent requirements on residual error rates, overestimating the channel quality is worse. Especially if it is done for the transmission attempt before the delay budget, also referred to as latency requirement, runs out.

To avoid overestimating the channel quality, a margin may be deducted from the measured link quality before using it for selecting transmission parameters. This leads to lower probabilities of over-estimating the link quality, but also has a cost in that inefficient transmission parameters are selected.

FIG. 3 and FIG. 4 show the performance in terms of throughput, see FIG. 3, and residual BLER, see FIG. 4, for two different types of interference. It should be clarified that the two different cases are created by using two different interference models with the same type of system. When time-varying interference is added, it is observed that higher backoff value is applied to the link quality, in order to ensure the BLER threshold 1e-4, see FIG. 4. More specifically, due to fluctuations of the interference in time domain, higher margin is needed for the required reliability at the cost of throughput.

FIG. 3 depicts throughput vs SINR. Degradation of throughput performance when time-varying interference model is applied. Gaussian interference is used to denote the case where the interference, which is modelled as Gaussian noise, has a power that is stationary over time.

FIG. 4 depicts residual BLER vs SINR. Higher mean SINR values needed to ensure the required error rate performance for the case of time-varying interference model.

An object of embodiments herein is to enhance the performance in a wireless communications network using a radio link adaptation.

According to an aspect of embodiments herein, the object is achieved by method performed by a first network node for adapting a radio link to a User Equipment, UE, served by the first network node in a wireless communications network. Respective channel quality measurement resources are pre-allocated for each of one or more neighbouring network nodes for transmitting respective signals of one or more long-term power levels. The long-term power levels are functions of instantaneous power levels of more than one time and frequency resource of a radio link. The first network node configures the UE to perform a channel quality measurement of the signals which are transmitted using the one or more long-term power levels by the one or more neighbouring network nodes in the pre-allocated channel quality measurement resources. The first network node receives a report from the UE. The report reports a first Channel Quality Indicator, CQI. The first CQI is calculated based on a channel quality measurement performed on the signals of the one or more long-term power levels according to the configuration. The first network node then adapts the radio link for a transmission to the UE based on the received first CQI.

According to an aspect of embodiments herein, the object is achieved by a method performed by a second network node for assisting a first network node in adapting a radio link to a User Equipment, UE, served by the first network node in a wireless communications network. Respective channel quality measurement resources are pre-allocated for each of one or more neighbouring network nodes, for transmitting respective signals of one or more long-term power levels. The long-term power levels are functions of instantaneous power levels of more than one time and frequency resource of a radio link, and wherein the one or more neighbouring network nodes comprises the second network node. The second network node transmits signals of one or more long-term power levels in the pre-allocated channel quality measurement resources according to the configuration. The transmitted signals enable the first network node to adapt the radio link for a transmission to the UE.

According to an aspect of embodiments herein, the object is achieved by a method performed by a User Equipment, UE, for assisting a first network node in adjusting a radio link between the first network node to the UE in a wireless communications network. The UE is served by the first network node. Respective channel quality measurement resources are pre-allocated for each of one or more neighbouring network nodes for transmitting respective signals of one or more long-term power levels. The long-term power levels are functions of instantaneous power levels of more than one time and frequency resource of a radio link. The UE receives a configuration from the first network node. The configuration configures the UE to perform a channel quality measurement of the signals which are transmitted using the one or more long-term power levels by the one or more neighbouring network nodes in the pre-allocated channel quality measurement resources. The UE performs a channel quality measurement on the signals according to the configuration. The UE calculates a first Channel Quality Indicator, CQI, based on the channel quality measurement performed on the signals of the one or more long-term power levels. The UE sends a report to the first network node. The report reports the calculated first CQI, enabling the first network node to adapt the radio link for a transmission, to the UE.

According to another aspect of embodiments herein, the object is achieved by a first network node configured to adapt a radio link to a User Equipment, UE, served by the first network node in a wireless communications network. Respective channel quality measurement resources are arranged to be pre-allocated for each of one or more neighbouring network nodes for transmitting respective signals of one or more long-term power levels. The long-term power levels are arranged to be functions of instantaneous power levels of more than one time and frequency resource of a radio link. The first network node is further configured to:
Configure the UE to perform a channel quality measurement of signals which are transmitted using the one or more long-term power levels by the one or more neighbouring network nodes in the pre-allocated channel quality measurement resources,
receive a report from the UE, which report is arranged to report a first Channel Quality Indicator, CQI, wherein the first CQI is to be calculated based on a channel quality measurement performed on the signals of the one or more long-term power levels according to the configuration, and
adapt the radio link for a transmission to the UE based on the first CQI.

According to another aspect of embodiments herein, the object is achieved by a second network node configured to assist a first network node in adapting a radio link to a User Equipment, UE, arranged to be served by the first network node in a wireless communications network. Respective channel quality measurement resources are arranged to be pre-allocated for each of one or more neighbouring network nodes, for transmitting respective signals of one or more long-term power levels. The long-term power levels are arranged to be functions of instantaneous power levels of more than one time and frequency resource of a radio link. The one or more neighbouring network nodes are arranged to comprise the second network node. The second network node is further configured to:
Transmit signals of one or more long-term power levels in the pre-allocated channel quality measurement resources according to the configuration, which transmitted signals are arranged to enable the first network node to adapting the radio link for a transmission to the UE.

According to another aspect of embodiments herein, the object is achieved by a User Equipment, UE, configured to assist a first network node in adjusting a radio link between the first network node to the UE in a wireless communications network. The UE is arranged to be served by the first network node. Respective channel quality measurement resources are arranged to be pre-allocated for each of one or more neighbouring network nodes for transmitting respective signals of one or more long-term power levels. The long-term power levels are arranged to be functions of instantaneous power levels of more than one time and frequency resource of a radio link. The UE is further configured to:
Receive a configuration from the first network node, which configuration arranged to configure the UE to perform a channel quality measurement of the signals which are to be transmitted using the one or more long-term power levels by the one or more neighbouring network nodes in the pre-allocated channel quality measurement resources,
perform a channel quality measurement on the signals according to the configuration,
calculate a first Channel Quality Indicator, CQI, based on the channel quality measurement performed on the signals of the one or more long-term power levels,
send a report to the first network node, which report is arranged to report the calculated first CQI, enabling the first network node to adapt the radio link for a transmission, to the UE.

Thanks to that the first CQI is calculated based on a channel quality measurement performed on the signals of the one or more long-term power levels a lower margin to the link quality is required to ensure the same error rate. This is because the margin only needs to cover the effect of the varying noise and interference levels on the actual data transmission, whereas in the prior art the margin needs to cover also the case of varying interference on the measurement resource. By having lower margin, the throughput performance is enhanced.

Some advantages provided by embodiments herein e.g. comprises that the whole process regarding the channel quality measurement configuration, and addition of interference, is carried out in the first network node, so the complexity in the UE is not increased, nor is any changes to the NR specification required.

### BRIEF DESCRIPTION OF THE DRAWINGS

Examples of embodiments herein are described in more detail with reference to attached drawings in which:

FIG. 1 is a schematic block diagram illustrating prior art.

FIGS. 2a and b are a schematic diagrams illustrating prior art.

FIG. 3 is a diagram illustrating prior art.

FIG. 4 is a diagram illustrating prior art.

FIG. 5 is a schematic block diagram illustrating embodiments of a wireless communications network.

FIG. 6 is a flowchart depicting an embodiment of a method in a first network node.

FIG. 7 is a flowchart depicting an embodiment of a method in a second network node.

FIG. 8 is a flowchart depicting an embodiment of a method in a UE.

FIG. 9 is a schematic block diagram illustrating embodiments of a method.

FIG. 10 is a schematic block diagram illustrating embodiments of a method.

FIG. 11 is a schematic block diagram illustrating embodiments of a method.

FIG. 12 is a diagram illustrating embodiments herein.

FIG. 13 is a diagram illustrating embodiments herein.

FIG. 14 is a diagram illustrating embodiments herein.

FIG. 15 is a diagram illustrating embodiments herein.

FIGS. 16a and b are schematic block diagrams illustrating embodiments of a first network node.

FIGS. 17a and b are schematic block diagrams illustrating embodiments of a second network node.

FIGS. 18a and b are schematic block diagrams illustrating embodiments of a UE.

FIG. 19 schematically illustrates a telecommunication network connected via an intermediate network to a host computer.

FIG. 20 is a generalized block diagram of a host computer communicating via a base station with a user equipment over a partially wireless connection.

FIGS. 21-24 are flowcharts illustrating methods implemented in a communication system including a host computer, a base station and a user equipment.

### DETAILED DESCRIPTION

Example embodiments herein relates to CSI measurement resources for robust link adaptation.

Example embodiments may e.g. refer to Link adaptation (LA), Channel State Information—Interference Measurement (CSI-IM), Channel State Information—Reference Signal (CSI-RS), BLER, Channel Quality Indicator (CQI), Hybrid Automatic Repetition Scheme (HARQ), and Signal-to-interference-plus-noise ratio (SINR).

According to some embodiments herein, a UE estimates and reports a link quality that is closer to a longer term expectation, and a network node uses the resulting report for LA, possibly selectively depending on a delay bound.

Channel quality measurement resources such as e.g. CSI-IM and/or CSI-RS are configured, e.g. for a UE, e.g. with Higher-Reliability and Low-Latency Communication (HRLLC) requirements. For example, transmissions may be arranged such that the resources, on which link quality are measured, are exposed to a level of interference that reflects longer term channel quality, e.g. geometry, for example by ensuring that neighbouring network nodes serving neighbouring cells transmit in channel quality measurement resources, regardless if they have any UE to serve or not. The power level thus transmitted may e.g. be selected to reflect an average load level, or a maximum load level.

When arranged in this way, the UE will measure a covariance on the channel quality measurement resources such as the CSI-IM. To measure a covariance on these resources e.g. means performing OFDM demodulation, then extract the signal samples on subcarriers associated with the CSI-IM resource and compute an average of products or these signal samples or the complex conjugate of them. The result then reflects the UE specific geometry and the load levels in the cells that create interference. This means that the UE may estimate an SINR that reflects the long term expected SINR.

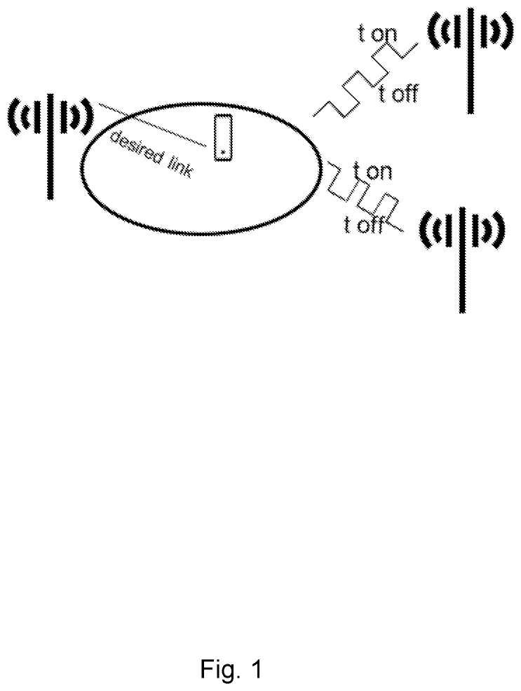

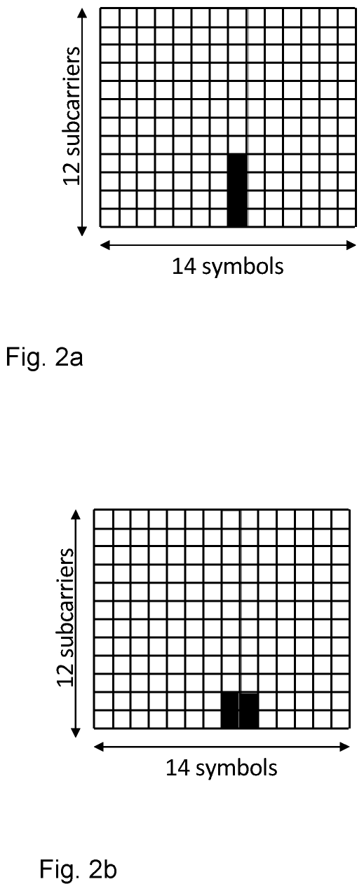

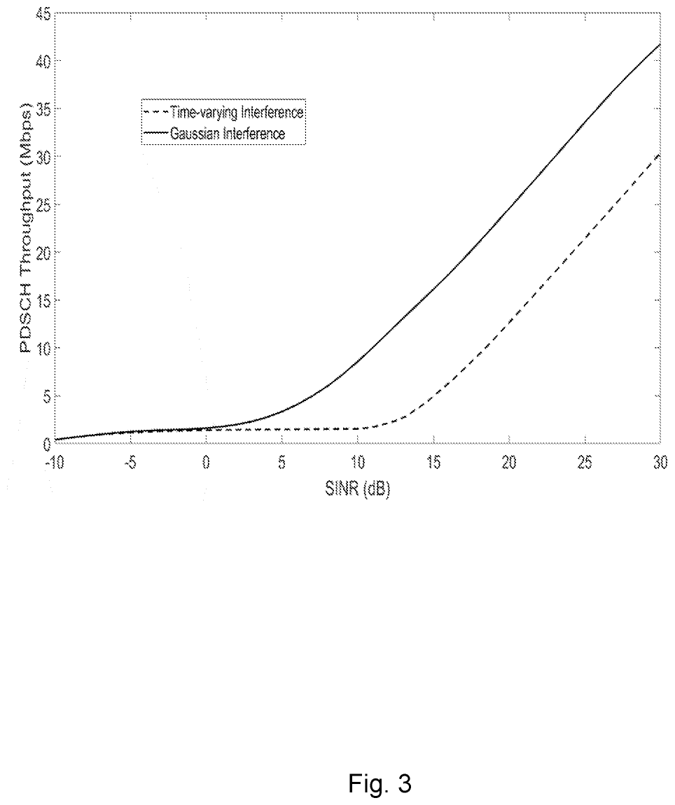

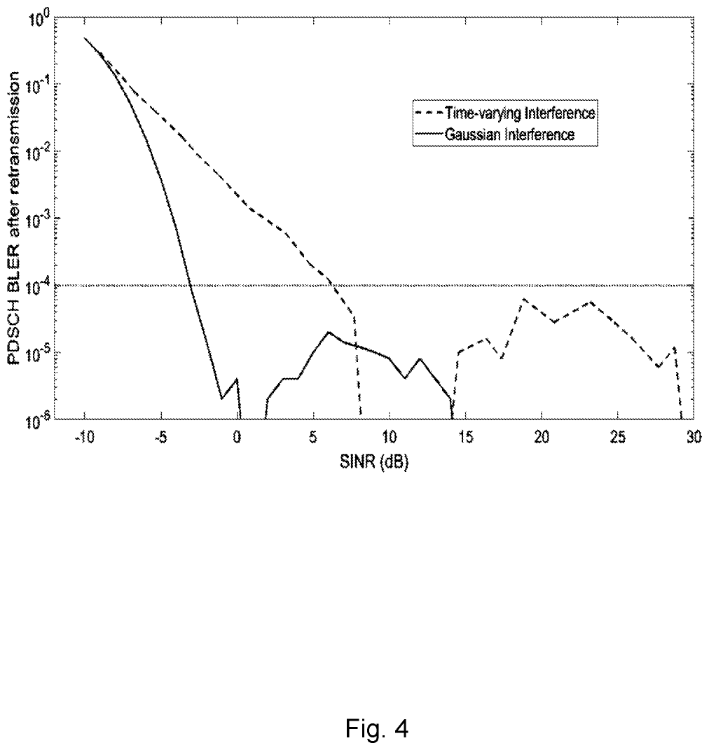

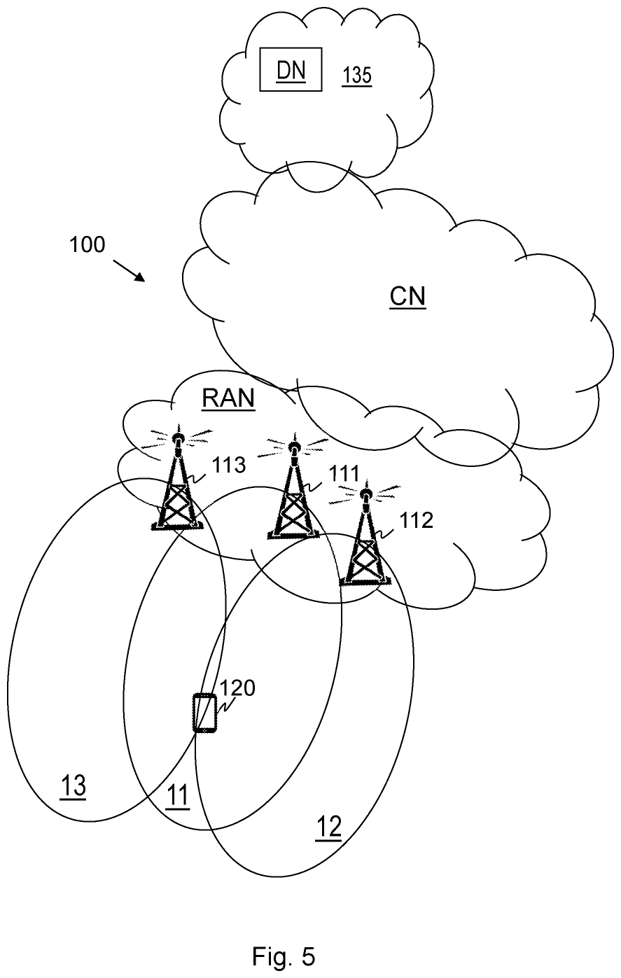

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as mmWave communication networks, Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), Internet of Things (IoT) just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a first network node 111, a second network node 112, and in some embodiments a third network node 113. The network nodes 111, 112, 113 each provides radio coverage in one or more cells which may also be referred to as a service area, a beam or a beam group of beams, such as e.g. a respective cell 11, cell 12 and cell 13. The second network node 112 and in some embodiments the third network node 113 are neighboring to the first network node 111 and are therefore referred to as one or more neighbouring network nodes 112, 113.

The network nodes 111, 112, 113 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, an NG-RAN node, a base transceiver station, a radio remote unit, an Access Point Base Station, a base station router, a transmission arrangement of a radio base station, a stand-alone access point or any other network unit capable of communicating with UEs, such as e.g. a UE 121, within the service area served by the network node 110 depending e.g. on the first radio access technology and terminology used. The network nodes 111, 112, 113 may communicate with UEs such as a UE 121, in DL transmissions to the UEs and UL transmissions from the UEs.

A number of UEs operate in the wireless communication network 100, such as e.g. the UE 121. The UE 121 may also referred to as a device, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g., smart phone, laptop, mobile phone, sensor, relay, mobile tablets or even a small base station communicating within a cell.

The UE 121 may e.g. be served by the first network node 111, e.g. when being located in cell 11.

Methods herein may be performed by the UE 121, the first network node 111, and the second network node 112. As an alternative, a Distributed Node (DN) and functionality, e.g. comprised in a cloud 135 as shown in FIG. 1, may be used for performing or partly performing the methods herein.

Example embodiments herein may include four steps
1. All neighboring network nodes 112, 113 transmit respective signals of one or more long-term power levels, on pre-allocated channel quality measurement resources. This may also be referred to as all neighboring network nodes 112, 113 are transmitting noise on pre-allocated channel quality measurement resources e.g. with a fixed power.
2. The serving first network node 111 configure the UE 121 to perform a channel quality measurement e.g. CSI-IM such that the UE measures interference on resources where some or all potential interfering neighboring network nodes 112, 113 are transmitting the signals, e.g. noise mentioned in step 1.
3. The UE 121 measures i channel quality such as e.g. interference on one or more pre-allocated channel quality measurement resources CSI-IM and use this to compute a CQI report.
4. The serving first network node 111 uses the CQI report to adapt a radio link for a transmission to the UE 121 e.g. by determining MCS.

In this way, the neighboring network nodes 112, 113 transmit signals that reflect long-term power levels on resource elements and the UE 121 will use them for interference measurement.

A number of embodiments will now be described, some of which may be seen as alternatives, while some may be used in combination.

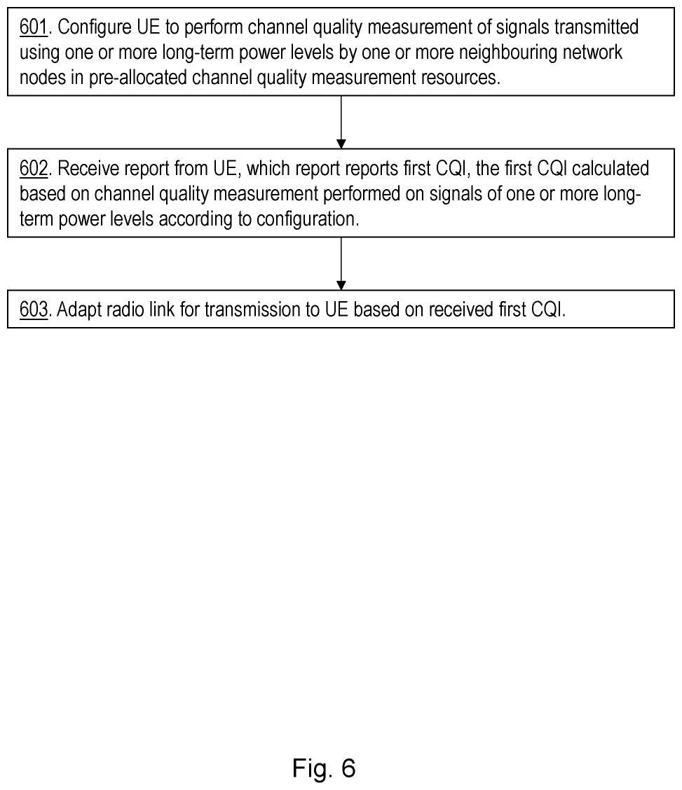

FIG. 6 shows example embodiments of a method performed by the first network node 111 for adapting a radio link to the UE 121. The UE 121 is served by the first network node 111 in the wireless communications network 100. Adapting a radio link may e.g. comprise LA, which determines one or more of a modulation and coding scheme, time frequency allocation, precoder, power level, and rank.

Respective channel quality measurement resources are pre-allocated for each of the one or more neighbouring network nodes 112, 113 for transmitting respective signals of one or more long-term power levels. This means that one neighbouring network node 112, 113 may be configured with more than one different long-term power levels. Pre-allocated when used herein e.g. means configured prior to configuring the UE with the channel quality measurement resource. Long-term power levels e.g. relates to a long-term estimate which may be an estimate of the neighboring network nodes 112, 113 traffic load compared to full traffic load. Such an estimate may for example be based on statistics of what the traffic normally looks like on during this time of day and day of week/month/year and be found in a look up table. It may also be based on the average load neighbouring network nodes 112, 113 has experienced during the last time window of T seconds where T may be anything from fractions of seconds to several hours. The interference measured by the user on the CSI-IM would then correspond to some long-time average, a power level that reflects statistics of the data channel load over multiple slots (typically over multiple CSI-reporting intervals.

The long-term power levels are functions of instantaneous power levels of more than one time and frequency resource of a radio link. This means that it is a function of the power level as integrated over multiple slots and/or data channel scheduling events.

The long-term power level for a network node X may e.g. a function of the historic power levels for the network node X.

The pre-allocated channel quality measurement resources may comprise any one or more out of: CSI-IM resources, and CSI-RS resources.

The one or more long-term power levels may be functions of any one or more out of: An average traffic load level, a maximum traffic load level, and historic power levels, of the respective one or more neighbouring network nodes 112, 113. The traffic load relates to data traffic and/or control traffic between a UE and a network node.

The one or more long-term power levels pre-allocated for each of one or more neighbouring network nodes 112, 113 for the channel quality measurement resources may comprise different levels of fixed power on different pre-allocated channel quality measurement resources. An advantage of this may relate to that the link margin only needs to cover the effect of the varying noise and interference levels on the actual data transmission compared to a longer-term average, whereas in the prior art the margin needs to cover also the case of varying interference on the measurement resource and so needs to be larger. By having lower margin, the throughput performance will be enhanced.

The method comprises the following actions, which actions may be taken in any suitable order. Optional actions are referred to as dashed boxes in FIG. 6.

### Action 601

The first network node 111 configures the UE 121 to perform a channel quality measurement of the signals. This channel quality measurement may be referred to as a first channel quality measurement, but for simplicity, they are just referred to the “channel quality measurement”. Below, a second channel quality measurement is mentioned, and this is really referred to as the “second channel quality measurement” to be differentiated from the “channel quality measurement”. These signals are transmitted by the one or more neighbouring network nodes 112, 113, by using the one or more long-term power levels in the pre-allocated channel quality measurement resources.

In some embodiments, the first network node 111 may further configure the UE 121 to perform one or more second channel quality measurements with any one or more out of:
Fluctuating interference, when the one or more neighbouring network nodes 112, 113 transmit data to its respective served second UEs 122, 123, and
full interference, when the one or more neighbouring network nodes 112, 113 transmit always-on signals.

### Action 602

The first network node 111 receives a report from the UE 121. The report reports a first CQ. Note that the term CQI is here used in a wide sense to represent an indication of channel characteristics, and not necessarily limited to what is included in standardized CQI reports. The first CQI is calculated based on a channel quality measurement performed on the signals of the one or more long-term power levels according to the configuration.

The first CQI may be referred to as a CQI for long-term expectation.

In some embodiments, UE 121 is configured 601 the to perform one or more second channel quality measurements with any one or more out of:
Fluctuating interference, when the one or more neighbouring network nodes 112, 113 transmit data to its respective served second UEs 122, 123, and
full interference, when the one or more neighbouring network nodes 112, 113 transmit always-on signals.

In these embodiments, the first network node 111 may receive of the report from the UE 121, further reports one or more second CQIs, calculated based on the one or more second channel quality measurements.

### Action 603

The first network node 111 then adapts the radio link for a transmission to the UE 121 based on the received first CQI. In some embodiments this means e.g. that the first network node 111 performs LA. This may e.g. be for finding appropriate modulation scheme, channel coding and rank depending which depends on the link quality e.g., SINR. As mentioned above, the aim of the LA may be to manage to adapt to varying interference conditions and select parameters to achieve a specific BLER and/or maximize the data rate.

In the embodiments, where the first network node 111 has received a report from the UE 121, reporting one or more second CQIs, calculated based on the one or more second channel quality measurements, the first network node 111 adapts the radio link for a transmission to the UE 121 further based on the received one or more second CQIs.

In the embodiments, the adapting of the radio link for the transmission to the UE 121 based on the one or more received second CQI may comprise:

Determining that the first CQI based on the channel quality measurement will be used for packets with a BLER requirement below the threshold, which channel quality measurements relate to a measurement with long-term interference.

Determining that one of the one or more second CQI that is based on the second channel quality measurement with fluctuating interference will be used for packets with a BLER requirement equal to or above a threshold, and

Determining that another one of the one or more second CQI being based on the second channel quality measurement with full interference will be used for packets with the most stringent requirements on BLER.

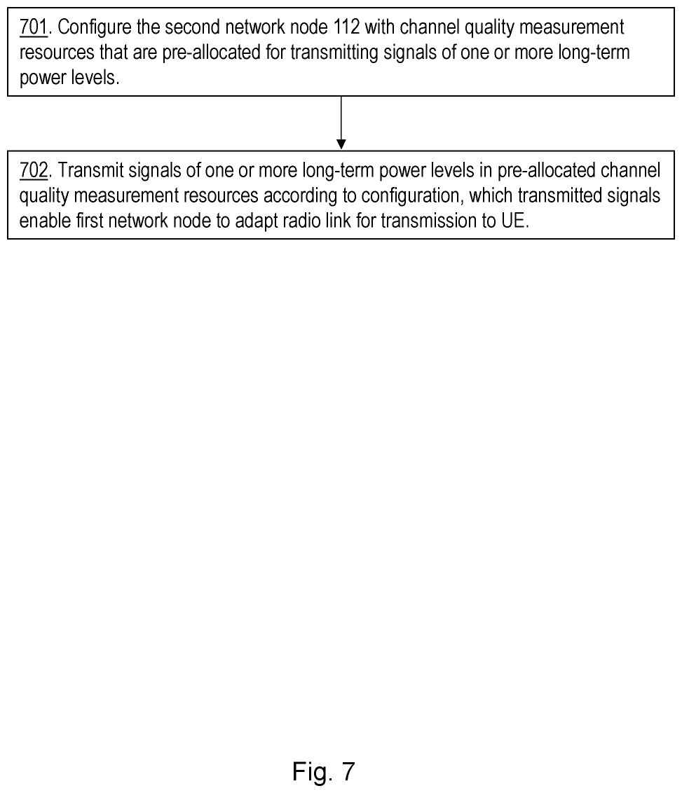

FIG. 7 shows example embodiments of a method performed by the second network node 112 for assisting the first network node 111 in adapting a radio link to the UE 121. The UE 121 is served by the first network node 111 in a wireless communications network 100.

The method comprises the following actions, which actions may be taken in any suitable order. Optional actions are referred to as dashed boxes in FIG. 7.

### Action 701

Respective channel quality measurement resources are pre-allocated for each of one or more neighbouring network nodes 112, 113, for transmitting respective signals of one or more long-term power levels. The long-term power levels are functions of instantaneous power levels of more than one time and frequency resource of a radio link. The one or more neighbouring network nodes 112, 113 comprises the second network node 112. Thus, the second network node 112 is configured with channel quality measurement resources that are pre-allocated for transmitting signals of one or more long-term power levels.

The pre-allocated channel quality measurement resources may comprise any one or more out of: CSI-IM resources, and CSI-RS resources.

### Action 702

The second network node 112 transmits signals of one or more long-term power levels in the pre-allocated channel quality measurement resources according to the configuration. The transmitted signals enable the first network node 111 to adapting the radio link for a transmission to the UE 121.

In some embodiments, the transmitting of the signals of the one or more long-term power levels in the pre-allocated channel quality measurement resources according to the configuration may:
enable the UE 121 to perform a channel quality measurement of the signals which are transmitted using the one or more long-term power levels by the one or more neighbouring network nodes 112, 113 in the pre-allocated channel quality measurement resources, and
to calculate based on the channel quality measurement and report to the first network node 111, a first Channel Quality Indicator, CQI, to be used as a basis for adapting the radio link for a transmission to the UE 121.
This in turn enables the first network node 111 to adapting the radio link for a transmission to the UE 121.

The one or more long-term power levels may be functions of any one or more out of: An average traffic load level, a maximum traffic load level, and historic power levels, of the respective one or more neighbouring network nodes 112, 113.

The one or more long-term power levels pre-allocated for each of one or more neighbouring network nodes 112, 113 for the channel quality measurement resources may comprise different levels of fixed power on different pre-allocated channel quality measurement resources.

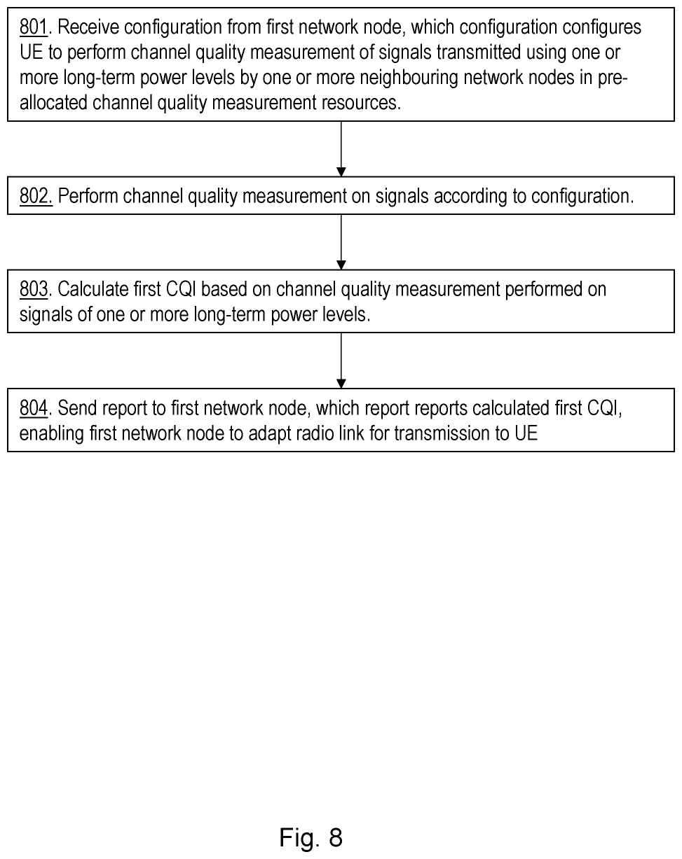

FIG. 8 shows example embodiments of a method performed by the UE 121 for assisting the first network node 111 in adjusting a radio link between the first network node 111 to the UE 121 in the wireless communications network 100. The UE 121 is served by the first network node 111. A respective channel quality measurement resources are pre-allocated for each of one or more neighbouring network nodes 112, 113 for transmitting respective signals of one or more long-term power levels. The long-term power levels are functions of instantaneous power levels of more than one time and frequency resource of a radio link.

The pre-allocated channel quality measurement resources may comprise any one or more out of: CSI-IM resources, and CSI-RS resources.

The one or more long-term power levels may be functions of any one or more out of: An average traffic load level, a maximum traffic load level, and historic power levels, of the respective one or more neighbouring network nodes 112, 113.

The one or more long-term power levels pre-allocated for each of one or more neighbouring network nodes 112, 113 for the channel quality measurement resources may comprise different levels of fixed power on different pre-allocated channel quality measurement resources.

The method comprises the following actions, which actions may be taken in any suitable order. Optional actions are referred to as dashed boxes in FIG. 8.

### Action 801

The UE 121 receives a configuration from the first network node 111. The configuration configures the UE 121 to perform a channel quality measurement of the signals. The signals are transmitted by the one or more neighbouring network nodes 112, 113 in the pre-allocated channel quality measurement resources using the one or more long-term power levels.

In some embodiments, the received configuration further configures the UE 121 to perform one or more second channel quality measurements with respective any one or more out of:
With fluctuating interference on CSI measurements resources, when the one or more neighbouring network nodes 112, 113 transmit data to its respective served second UEs 122, 123,
with full interference, when the one or more neighbouring network nodes 112, 113 transmit always-on signals.

### Action 802

The UE 121 performs a channel quality measurement on the signals according to the configuration.

In some embodiments, the UE 121 is further configured to perform one or more second channel quality measurements as mentioned in Action 801. In these embodiments, the UE 121 further performs the one or more second channel quality measurements according to the configuration.

### Action 803

The UE 121 calculates a first CQI based on the channel quality measurement performed on the signals of the one or more long-term power levels. This may be referred to as the Channel State Information (CSI) processing. This may be performed by following the procedures described in TS 38.214, Section 5.2.

In the embodiments, wherein the UE 121 further has performed the one or more second channel quality measurements according to the configuration in action. In these embodiments, the UE 121 calculates one or more second CQIs, based on the one or more second channel quality measurements.

### Action 804

The UE 121 then sends a report to the first network node 111. The report reports the calculated first CQI. The first CQI enables the first network node 111 to adapt the radio link for a transmission to the UE 121.

In the embodiments, wherein one or more second CQIs has been calculated, based on the one or more second channel quality measurements, the report sent to the first network node 111 further is reporting the calculated one or more second CQIs.

By using embodiments of the method described above, e.g. the following advantages are provided.

As mentioned above, when using the provided method according to embodiments herein, a lower margin to the link quality is required to ensure the same error rate. This is because the margin only needs to cover the effect of the varying noise and interference levels on the actual data transmission, whereas in the prior art the margin needs to cover also the case of varying interference on the measurement resource. By having lower margin, the throughput performance will be enhanced.

Another important advantage of embodiments herein is that the whole process regarding the configuring of the channel quality measurement of the signals which are transmitted using the one or more long-term power levels such as the CSI-IM configuration, and addition of interference, is carried out in the first network node 111, so the complexity in the UE 121 is not increased, nor is changes to the NR specification required.

The above embodiments will now be further explained and exemplified below. The embodiments below may be combined with any suitable embodiment above.

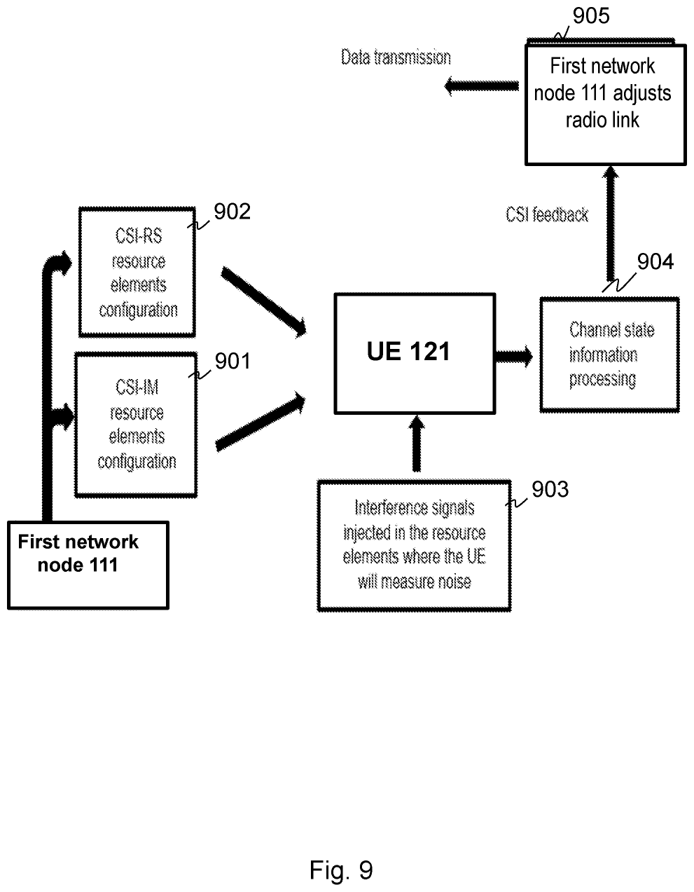

FIG. 9 describes an example of a system overview, and how the configured CSI-IM 901 and/or CSI-RS 902 resources capture the interference activity from neighboring cells provided by the neighbouring network nodes 112, 113. Interference signals are injected in the resource elements where the UE 121 will perform the channel quality measurement such as e.g. measure noise 903 such as using the CSI-IM 901 and/or CSI-RS 902 resources. This is related to and may be combined with Action 802 described above.

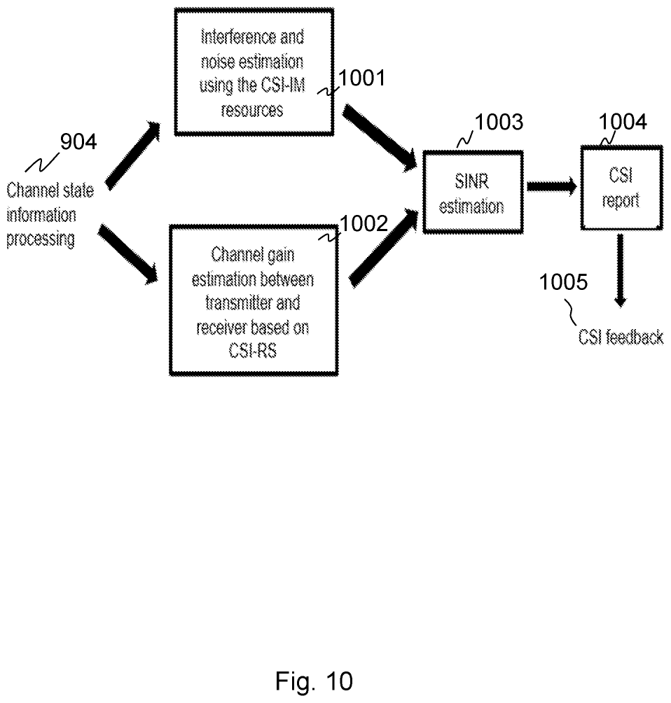

An overview of the channel state information processing 904 at the UE 121 is depicted in FIG. 10. The UE 121 will perform the channel quality measurement e.g. measure noise such as estimate SINR 1003 by as using the CSI-IM 1001 and/or CSI-RS 1002 resources, and calculate a CSI 1004 and report it as feedback 1005 to the first network node 111. This is related to and may be combined with Actions 802, 803, 804, and 603 described above.

Referring again to FIG. 9, after the Channel State Information processing by the UE 121, CSI feedback conveys this information to the serving base station for adjusting the radio link, e.g. LA 905.

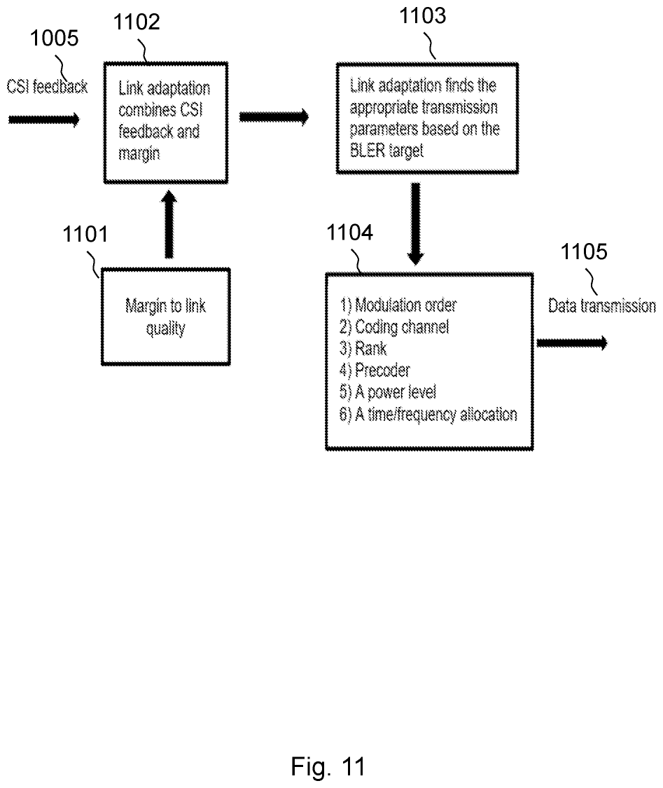

An overview of the radio link adaptation process 905 at the first network node 111 before data transmission is depicted in FIG. 11. This is related to and may be combined with Actions 803, 804, 603 and 604 described above. The first network node 111 receives the CSI feedback and performs link adaptation combining 1102 CSI feedback with the link margin.

By performing the link adaptation the first network node 111 finds 1103, also referred to as selects, appropriate transmission parameters based on the BLER target. By using the radio link adaptation such as the LA, the first network node 111 may thus select the appropriate parameters for the data transmission 1104 such as:
1) Modulation order
2) Channel coding
3) Rank
4) Precoder
5) A power level
6) a time/frequency allocation

The first network node 111 then performs the data transmission 1105 over the adapted radio link by using the selected parameters.

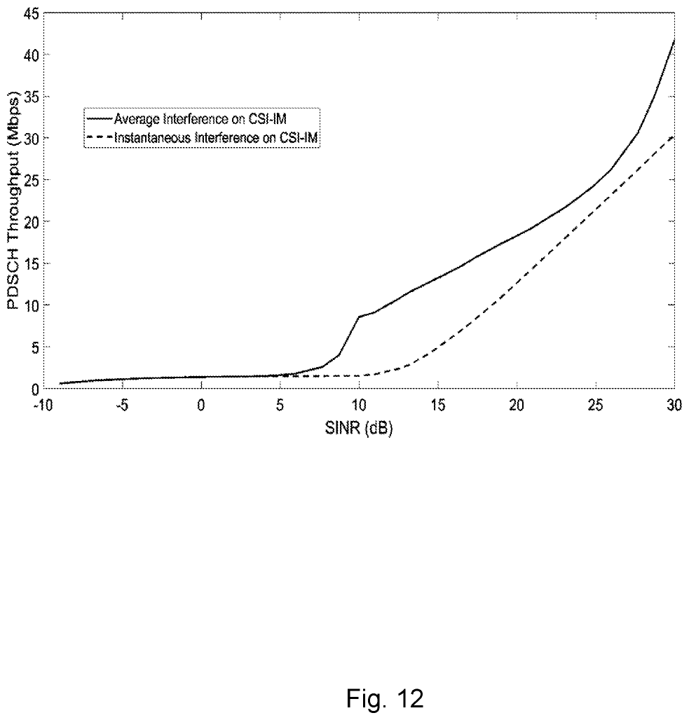

FIG. 12 depicts a throughput performance of the radio link according to an example of embodiment herein, for the cases where the CSI-IM resources have been configured to measure the average (solid line) and instantaneous (dashed line) interference respectively. FIG. 12 thus illustrates the performance according to an example of embodiment herein, in terms of throughput of the radio link when the channel quality measurement resources such as the CSI-IM resource elements are configured to measure the noise power and long-term expectation of interference (solid line) and when they are configured to measure the instantaneous (dashed line) noise and interference.

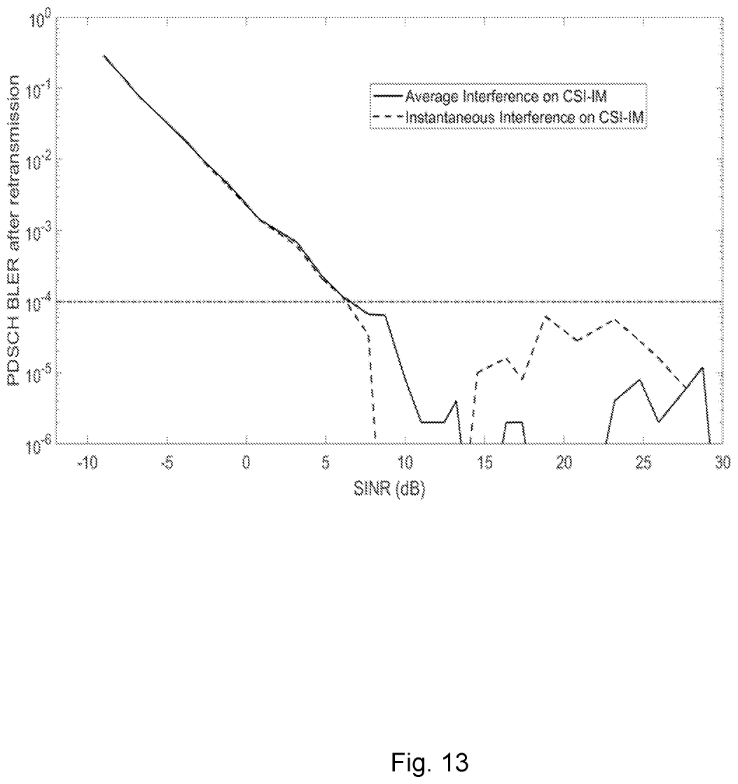

It should be highlighted that the same time-varying interference model has been applied to both cases. Both curves show the throughput according to embodiments herein, may achieve while at the same time achieving a BLER at 1e-4, see FIG. 13. FIG. 13 depicts an example according to embodiments herein, of a residual BLER performance for the cases where the CSI-IM resources have been configured to measure the average (solid line) and instantaneous (dashed line) interference respectively. It can be observed that the data rate performance is higher at the mid and higher SINR values when the users measure a long-term expectation of noise and interference on the CSI-IM instead of measuring the instantaneous noise and interference caused by regular data transmission. That occurs since the interference measurements may be used from the LA, so lower margin to the estimated link quality is required to achieve the BLER target, see FIG. 13, leading to higher throughput performance.

As previously stated, according to example embodiments herein, the pre-allocated channel quality measurement resources such as the CSI-IM resources may be configured and transmission arranged to make the UE 121 measure e.g. the highest interference level or the longer-term expectation from the neighboring cells provided by the one or more neighbouring network nodes 112, 113. Thus, it should be ensured that the CSI-IM resources configured from the serving cell provided by the first network node 111 will capture the correct average or longer-term interference level and use this information of the link quality to the LA. This means that the interference levels, or covariance measured by a served UE such as the UE 121, on its configured channel quality measurement resources reflects a longer-term average of the interference expected on the shared data channel.

Cell planning e.g. of the cells provided by the network nodes 111, 112, 113.

Cell planning is needed to ensure that a serving base station, such as the first network node 111, can configure CSI-IM on specific resource elements where the interferers will always transmit with a fixed power, e.g. for transmitting the respective signals of one or more long-term power levels.

In one embodiment the cell planning may be set up during a network design, e.g. using a reuse X scheme.

In some embodiments the cell planning may be re-configured when a new neighboring cell is created.

The appropriate configuration of the resource elements capturing the interference may be imperative. E.g. two alternatives are provided to measure the interference, these are: CSI-IM configuration and Non-Zero Power (NZP) CSI-RS configuration.

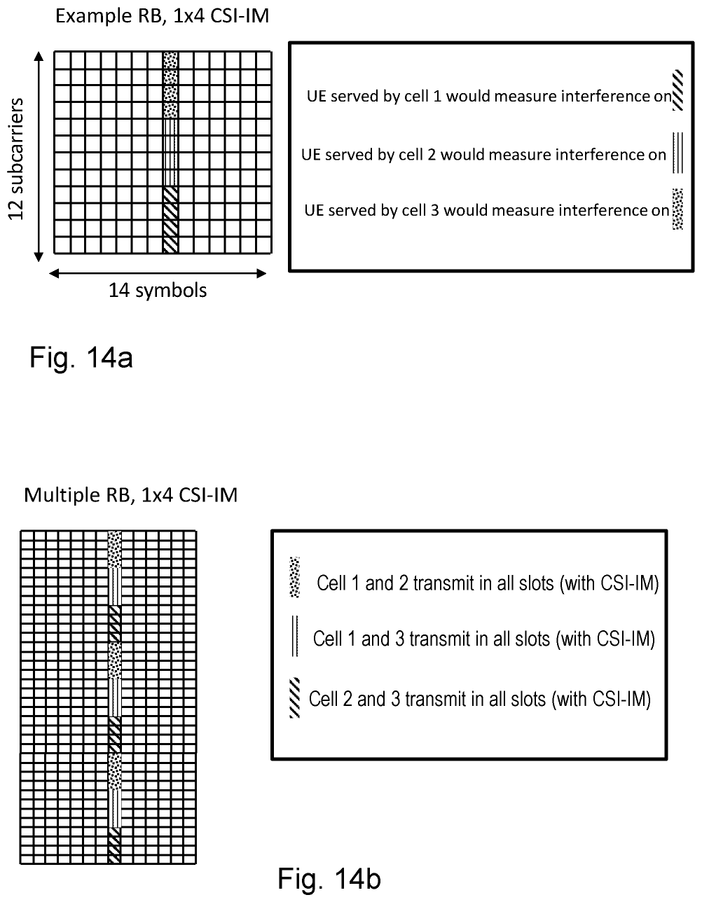

FIGS. 14a and b depict a CSI-IM configuration for one UE such as the UE 121, and three cells, cell 1, cell 2, cell 3, e.g. provided by the first network node 111 and the one or more neighbouring network nodes 112, 113. FIGS. 14a and b demonstrate how the CSI-IM resource elements may be configured. FIG. 14a depicts an example with a Radio Bearer (RB) 1×4 CSI-IM, and FIG. 14b depicts an example with Multiple RBs, 1×4 CSI-IM. For example, when the UE 121 is served from the cell 1 provided by the first network node 111, and when cell 2 and 3 provided by the neighbouring network nodes 112, 113, are interferers. The serving first network node 111 will configure the CSI-IM with 1×4 structure. Then, the neighbouring network nodes 112, 113 will have been scheduled to always transmit their signals on the same CSI-IM resources. Thus, these CSI-IM resource elements from the cell 1 will measure the total interference illustrated with slanted stripes in FIG. 14. The same process holds for the other cases when the UE 121 is served from another cell and receives interference from the rest 2 cells.

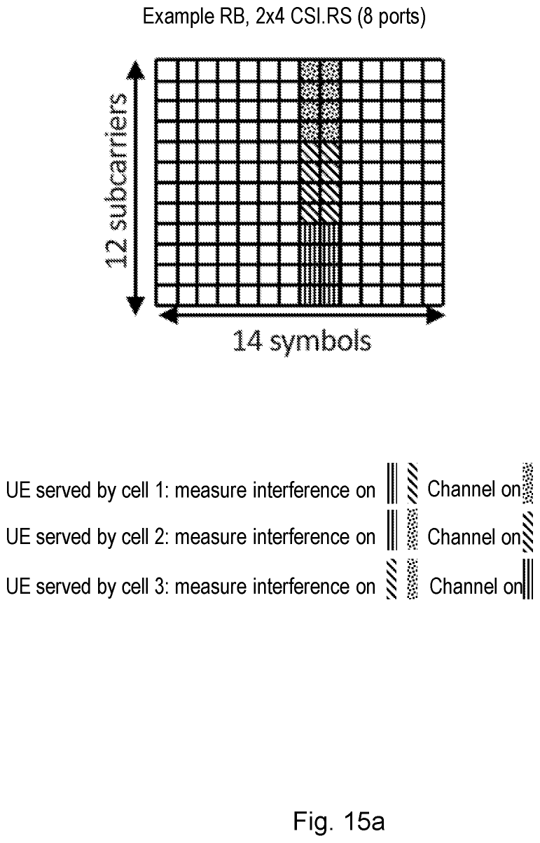

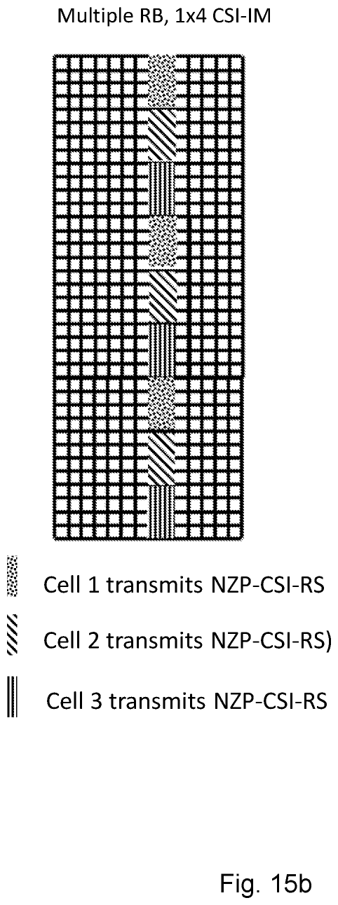

FIG. 15a and FIG. 15b depict NZP CSI-RS configurations for one UE such as the UE 121, and three cells, cell 1, cell 2, cell 3, e.g. provided by the first network node 111 and the one or more neighbouring network nodes 112, 113. FIG. 15a depicts an example with 2×4 CSI.RS, i.e. 8 ports, and FIG. 15b depicts an example with Multiple RBs, 1×4 CSI-IM.

FIGS. 15a and b illustrate how the NZP CSI-RS resources may be combined to measure channel quality, e.g. the interference and channel having a twofold role. Assume that the same example where the UE 121 is served from the cell 1 and receive interference from cells 2 and 3, the UE 121 will measure the sum of the CSI-RS signals from cells 2 and 3, horizontal stripes, and slanted stripes, respectively to estimate the interference and the red one from the serving cell for the channel estimation.

Transmit powers e.g. relating to the one or more long-term power levels.

In some embodiments, interfering base stations, such as the one or more neighbouring network nodes 112, 113 transmit noise/a pseudo random signal on the pre-allocated, also referred to as assigned resources, those where another UE may measure interference, and hence power corresponding to an estimated long-term load level of the interfering base station. The long-term power level may be an estimate of the base station traffic load compared to full traffic load. Such an estimate may for example be based on statistics of what the traffic normally looks like on during this time of day and day of week/month/year and be found in a look up table. It may also be based on the average load the base station has experienced during the last time window of T seconds where T may be anything from fractions of seconds to several hours. The interference measured by the UE 121 on the CSI-IM would then correspond to some long time average.

In some embodiments, the interfering base stations, such as the one or more neighbouring network nodes 112, 113 transmit on CSI-IM with the nominal Energy Per Resource Element (EPRE) of the cell. The interference measured by the UE 121 on the CSI-IM would then correspond to a worst case scenario interference. In this embodiment the signal transmitted on the assigned resources may be PDSCH if the UE 121 is served on those resources, or noise and/or pseudo random signal.

If noise and/or pseudo random signals are transmitted, the UE 121 served in the cell need to be configured to rate match PDSCH around those resources. This means that the UE is configured to disregard those resource elements when decoding PDSCH

### Multiple CQI Reports Based on Multiple CSI-IM

In some embodiments, the provided method to channel quality measurement may here be combined with additional CSI-IM configured to measure the fluctuating interference when the interfering base stations are serving users with data. The CQI based on CSI-IM measurements with fluctuating interference may then be used for packets with lower BLER requirements while the CQI based on CSI-IM measurement with long-term interference will then be used for packets with higher BLER requirements. For example, for a transmission second CQI report that is based on CSI-IM with fluctuating interference may be used, while for retransmissions the first CQI report based on the CSI-IM with interference reflecting the long-term interference can be used.

In some embodiments, the one or more neighbouring network nodes 112, 113 may transmit with different levels of fixed power on different pre-allocated resources. Then, multiple CSI-IM would be configured such that the UE 121 measures multiple long-term interference levels. For example, on one set of resources, set up for example as in FIG. 14, the one or more neighbouring network nodes 112, 113 will transmit with full power and on a different set of resources, set up for example as in FIG. 14, the one or more neighbouring network nodes 112, 113 may transmit with full power times a constant that may correspond to the fraction of time they expect to be serving. The CQI based on CSI-IM measurements with the lower interference level will then be used for packets with lower BLER requirements while the CQI based on CSI-IM measurement with the higher interference level will then be used for packets with higher BLER requirements.

To perform the method actions above, the first network node 111 is configured to adapt the radio link to the UE 121 served by the first network node 111 in the wireless communications network 100. Respective channel quality measurement resources are arranged to be pre-allocated for each of one or more neighbouring network nodes 112, 113 for transmitting respective signals of one or more long-term power levels. The long-term power levels are arranged to be functions of instantaneous power levels of more than one time and frequency resource of a radio link.

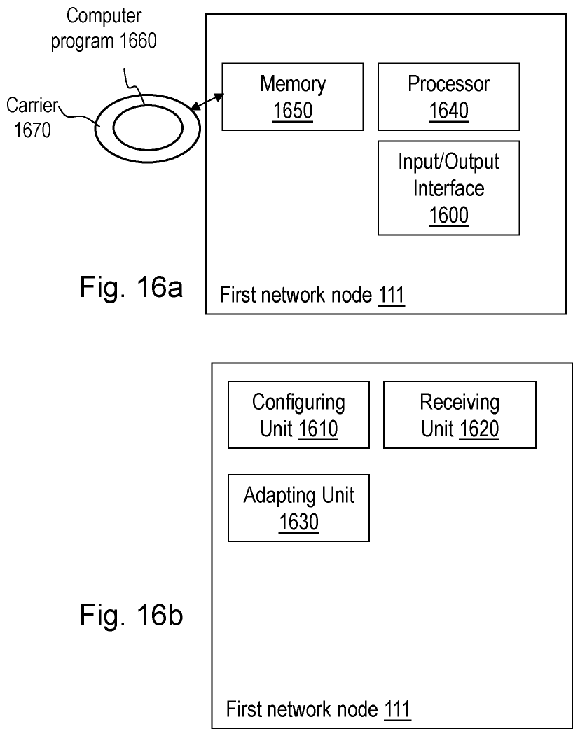

The first network node 111 may comprise an arrangement depicted in FIGS. 16a and 16b.

The first network node 111 may comprise an input and output interface 1600 configured to communicate with UEs such as e.g. the UE 121, and with other network nodes in the wireless communications network 100. The input and output interface 1600 may comprise a wireless receiver (not shown) and a wireless transmitter (not shown).

The first network node 111 is further configured to, e.g. by means of a configuring unit 1610 in the first network node 111, configure the UE 121 to perform a channel quality measurement of signals which are transmitted using the one or more long-term power levels by the one or more neighbouring network nodes 112, 113 in the pre-allocated channel quality measurement resources.

The pre-allocated channel quality measurement resources may comprise any one or more out of: CSI-IM resources and CSI-RS resources.

The one or more long-term power levels may be arranged to be functions of any one or more out of: An average traffic load level, a maximum traffic load level, and historic power levels, of the respective one or more neighbouring network nodes 112, 113.

The one or more long-term power levels pre-allocated for each of one or more neighbouring network nodes 112, 113 for the channel quality measurement resources may be arranged to comprise different levels of fixed power on different pre-allocated channel quality measurement resources.

The first network node 111 may further be configured to, e.g. by means of the configuring unit 1610 in the first network node 111, configure the UE 121 to further perform one or more second channel quality measurements with any one or more out of: Fluctuating interference, when the one or more neighbouring network nodes 112, 113 transmit data to its respective served second UEs 122, 123, and full interference, when the one or more neighbouring network nodes 112, 113 transmit always-on signals.

The first network node 111 is further configured to, e.g. by means of a receiving unit 1620 in the first network node 111, receive a report from the UE 121. The report is arranged to report a first CQI. The first CQI is to be calculated based on a channel quality measurement performed on the signals of the one or more long-term power levels according to the configuration.

The first network node 111 may further be configured to, e.g. by means of the receiving unit 1620 in the first network node 111, receive the report from the UE 121. The report is further arranged to report one or more second CQIs, arranged to be calculated based on the one or more second channel quality measurements.

The first network node 111 is further configured to, e.g. by means of an adapting unit 1630 in the first network node 111, adapt the radio link for a transmission to the UE 121 based on the first CQI.

The first network node 111 may further be configured to, e.g. by means of the adapting unit 1630 in the first network node 111, adapt the radio link for a transmission to the UE 121 further based on the one or more second CQIs.

The first network node 111 may further be configured to, e.g. by means of the adapting unit 1630 in the first network node 111, adapt the radio link for a transmission to the UE 121 further based on the one or more second CQI by:
Determine that the first CQI based on the channel quality measurement will be used for packets with a BLER requirement below the threshold. The channel quality measurements is arranged to relate to a measurement with long-term interference.
Determine that one of the one or more second CQI that is based on the second channel quality measurement with fluctuating interference is arranged to be used for packets with a BLER requirement equal to or above a threshold.
Determine that another one of the one or more second CQI being based on the second channel quality measurement with full interference is arranged to be used for packets with a BLER requirement below a second threshold.

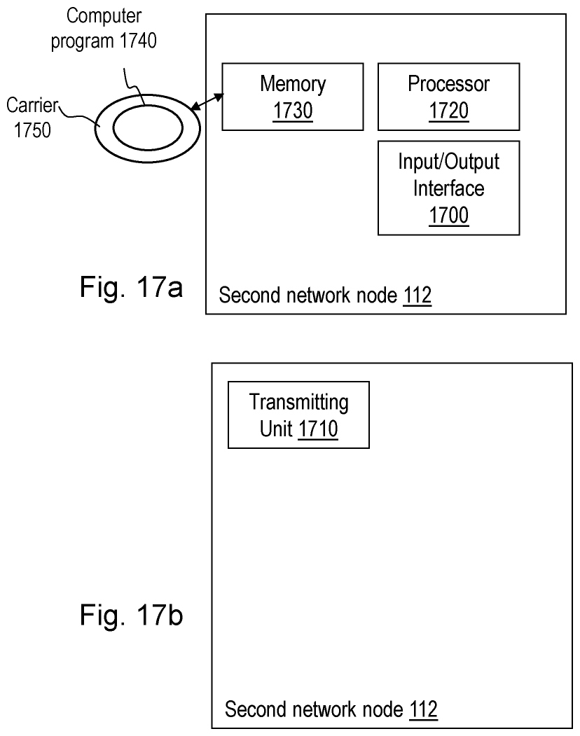

To perform the method actions above, the second network node 112 is configured to assist the first network node 111 in adapting a radio link to the UE 121 arranged to be served by the first network node 111 in the wireless communications network 100. Respective channel quality measurement resources are arranged to be pre-allocated for each of one or more neighbouring network nodes 112, 113, for transmitting respective signals of one or more long-term power levels. The long-term power levels are arranged to be functions of instantaneous power levels of more than one time and frequency resource of a radio link. The one or more neighbouring network nodes 112, 113 are arranged to comprise the second network node 112. The network node 110 may comprise an arrangement depicted in FIGS. 17a and 17b.

The second network node 112 may comprise an input and output interface 1700 configured to communicate with UEs such as e.g. the UE 121, and with other network nodes in the wireless communications network 100. The input and output interface 1700 may comprise a wireless receiver (not shown) and a wireless transmitter (not shown).

The second network node 112 is further configured to, e.g. by means of a transmitting unit 1710 in the second network node 112, transmit signals of one or more long-term power levels in the pre-allocated channel quality measurement resources according to the configuration. The transmitted signals are arranged to enable the first network node 111 to adapt the radio link for a transmission to the UE 121.

The signals of one or more long-term power levels to be transmitted in the pre-allocated channel quality measurement resources according to the configuration may be arranged to: Enable the UE 121 to perform a channel quality measurement of the signals which are transmitted using the one or more long-term power levels by the one or more neighbouring network nodes 112, 113 in the pre-allocated channel quality measurement resources, and to calculate based on the channel quality measurement and report to the first network node 111, a first CQI to be used as a basis for adapting the radio link for a transmission to the UE 121. The UE is in turn arranged to enable the first network node 111 to adapt the radio link for a transmission to the UE 121.

The pre-allocated channel quality measurement resources may be arranged to comprise any one or more out of: CSI-IM resources and CSI-RS resources.

The one or more long-term power levels may be arranged to be functions of any one or more out of: An average traffic load level, a maximum traffic load level, and historic power levels, of the respective one or more neighbouring network nodes 112, 113.

The one or more long-term power levels pre-allocated for each of one or more neighbouring network nodes 112, 113 for the channel quality measurement resources may be arranged to comprise different levels of fixed power on different pre-allocated channel quality measurement resources.

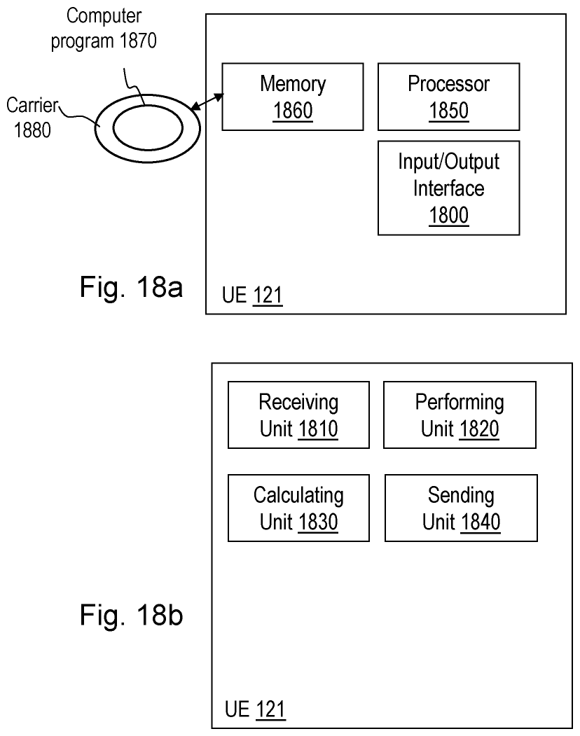

To perform the method actions above, the UE 121 is configured to assist the first network node 111 in adjusting a radio link between the first network node 111 to the UE 121 in the wireless communications network 100. The UE 121 is arranged to be served by the first network node 111. Respective channel quality measurement resources are arranged to be pre-allocated for each of one or more neighbouring network nodes 112, 113 for transmitting respective signals of one or more long-term power levels. The long-term power levels are arranged to be functions of instantaneous power levels of more than one time and frequency resource of a radio link. The network node 110 may comprise an arrangement depicted in FIGS. 18a and 18b.

The UE 121 may comprise an input and output interface 1800 configured to communicate with network nodes such as e.g. the first network node 111, and with other network nodes in the wireless communications network 100. The input and output interface 1800 may comprise a wireless receiver (not shown) and a wireless transmitter (not shown).

The network node 110 is further configured to, e.g. by means of a receiving unit 1810 in the UE 121, receive a configuration from the first network node 111. The configuration is arranged to configure the UE 121 to perform a channel quality measurement of the signals which are to be transmitted using the one or more long-term power levels by the one or more neighbouring network nodes 112, 113 in the pre-allocated channel quality measurement resources.

The pre-allocated channel quality measurement resources may be arranged to comprise any one or more out of: CSI-IM resources and CSI-RS resources.

The one or more long-term power levels may be arranged to be functions of any one or more out of: An average traffic load level, a maximum traffic load level, and historic power levels, of the respective one or more neighbouring network nodes 112, 113.

The one or more long-term power levels pre-allocated for each of one or more neighbouring network nodes 112, 113 for the channel quality measurement resources may be arranged to comprise different levels of fixed power on different pre-allocated channel quality measurement resources.

The received configuration may further configure the UE 121 to perform one or more second channel quality measurements with respective any one or more out of: With fluctuating interference, when the one or more neighbouring network nodes 112, 113 transmit data to its respective served second UEs 122, 123, and with full interference, when the one or more neighbouring network nodes 112, 113 transmit always-on signals.

The network node 110 is further configured to, e.g. by means of a performing unit 1820 in the UE 121, perform a channel quality measurement on the signals according to the configuration.

The network node 110 may further be configured to, e.g. by means of the performing unit 1820 in the UE 121, perform the one or more second channel quality measurements according to the configuration.

The network node 110 is further configured to, e.g. by means of a calculating unit 1830 in the UE 121, calculate the first CQI based on the channel quality measurement performed on the signals of the one or more long-term power levels.

The network node 110 may further be configured to, e.g. by means of the calculating unit 1830 in the UE 121, calculate one or more second CQIs based on the one or more second channel quality measurements.

The network node 110 is further configured to, e.g. by means of a sending unit 1840 in the UE 121, send the report to the first network node 111. The report is arranged to report the calculated first CQI, enabling the first network node 111 to adapt the radio link for a transmission, to the UE 121.

The network node 110 may further be configured to, e.g. by means of the sending unit 1840 in the UE 121, in the report sent to be to the first network node 111 further reporting the calculated one or more second CQIs.

The embodiments herein may be implemented through a respective processor or one or more processors, such as the processor 1640 of a processing circuitry in the first network node 111 depicted in FIG. 16a, the processor 1720 of a processing circuitry in the first the second network node 112 depicted in FIG. 17a and the processor 1850 of a processing circuitry in the first the UE 121 depicted in FIG. 18a, together with respective computer program code for performing the functions and actions of the embodiments herein. The program code mentioned above may also be provided as a computer program product, for instance in the form of a data carrier carrying computer program code for performing the embodiments herein when being loaded into either of the respective first network node 111, second network node 112 and UE 121. One such carrier may be in the form of a CD ROM disc. It is however feasible with other data carriers such as a memory stick. The computer program code may furthermore be provided as pure program code on a server and downloaded to either of the respective first network node 111, second network node 112 and UE 121.

The respective first network node 111, second network node 112 and UE 121 may further comprise a respective memory 1650, 1730, 1860 comprising one or more memory units. The memory 1650, 1730, 1860 comprises instructions executable by the processor in the respective first network node 111, second network node 112 and UE 121. The memory 1650, 1730, 1860 is arranged to be used to store e.g. information, indications, symbols, data, configurations, and applications to perform the methods herein when being executed in the respective first network node 111, second network node 112 and UE 121.

In some embodiments, a computer program 1660, 1740, 1870 comprises instructions, which when executed by the respective at least one processor 1640, 1720, 1850, cause the at least one processor of respective first network node 111, second network node 112 and UE 121 to perform the actions above.

In some embodiments, a respective carrier 1670, 1750, 1880 comprises the respective computer program 1660, 1740, 1870, wherein the carrier 1670, 1750, 1880 is one of an electronic signal, an optical signal, an electromagnetic signal, a magnetic signal, an electric signal, a radio signal, a microwave signal, or a computer-readable storage medium.

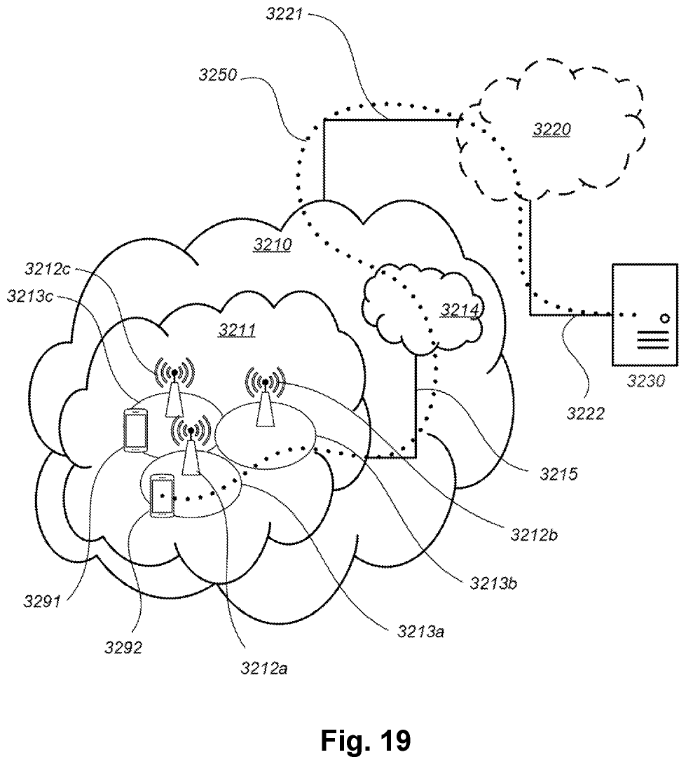

With reference to FIG. 19, in accordance with an embodiment, a communication system includes a telecommunication network 3210, such as a 3GPP-type cellular network, e.g. the wireless communications network 100, which comprises an access network 3211, such as a radio access network, and a core network 3214. The access network 3211 comprises a plurality of base stations 3212a, 3212b, 3212c, e.g. the network node 110, such as AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) such as a Non-AP STA 3291, e.g. the UE 121, located in coverage area 3213c is configured to wirelessly connect to, or be paged by, the corresponding base station 3212c. A second UE 3292 e.g. the UE 122, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 19 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

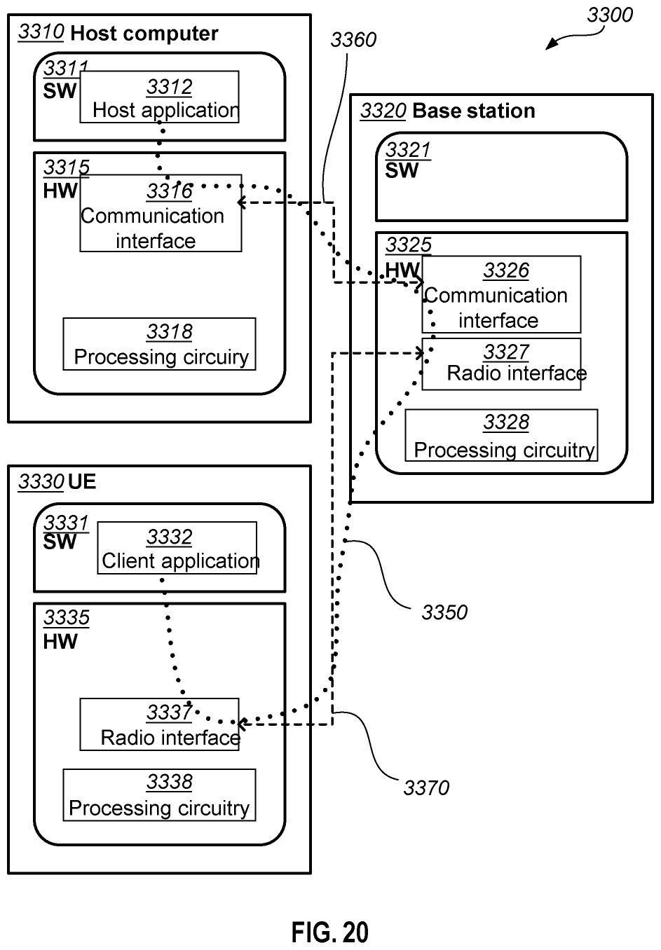

Example implementations, in accordance with an embodiment, of the UE, base station and host computer discussed in the preceding paragraphs will now be described with reference to FIG. 20. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 20 may be identical to the host computer 3230, one of the base stations 3212a, 3212b, 3212c and one of the UEs 3291, 3292 of FIG. 19, respectively. This is to say, the inner workings of these entities may be as shown in FIG. 20 and independently, the surrounding network topology may be that of FIG. 19.

In FIG. 20, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the RAN effect: data rate, latency, power consumption and thereby provide benefits such as corresponding effect on the OTT service: reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

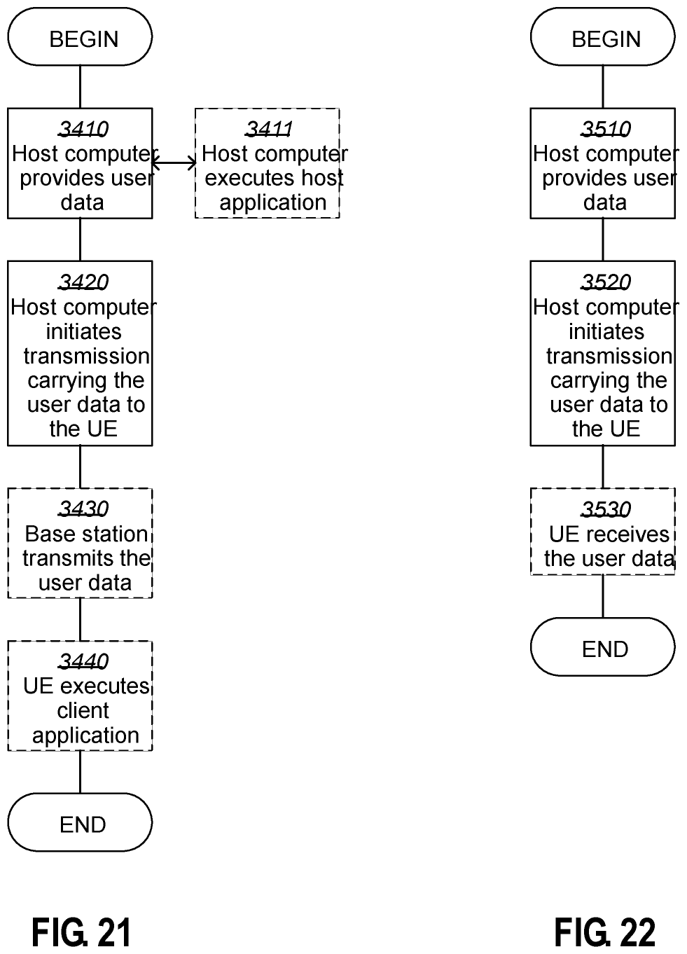

FIG. 21 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 20. For simplicity of the present disclosure, only drawing references to FIG. 21 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 22 is a flowchart illustrating a method implemented in a communication system, in accordance with one embodiment. The communication system includes a host computer, a base station such as a AP STA, and a UE such as a Non-AP STA which may be those described with reference to FIG. 19 and FIG. 20. For simplicity of the present disclosure, only drawing references to FIG. 22 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

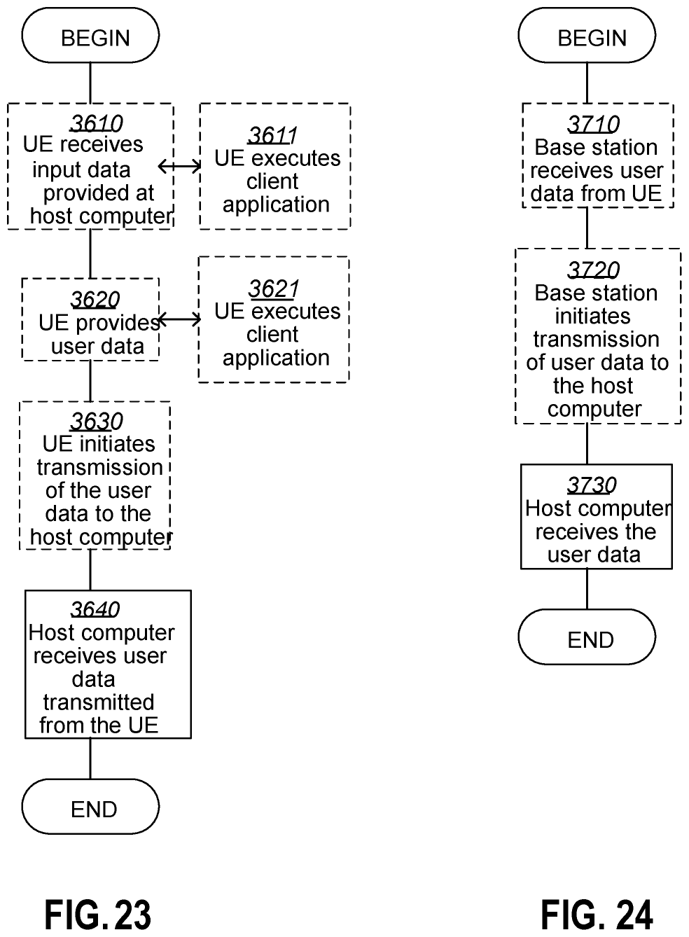

FIG. 23 is a flowchart illustrating a method implemented in a communication system, in accordance with one embodiment. The communication system includes a host computer, a base station such as an AP STA, and a UE such as a Non-AP STA which may be those described with reference to FIG. 19 and FIG. 20. For simplicity of the present disclosure, only drawing references to FIG. 23 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 24 is a flowchart illustrating a method implemented in a communication system, in accordance with one embodiment. The communication system includes a host computer, a base station such as a AP STA, and a UE such as a Non-AP STA which may be those described with reference to FIG. 15 and FIG. 16. For simplicity of the present disclosure, only drawing references to FIG. 24 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

1-38. (canceled)

39. A method performed by a first network node for adapting a radio link to a User Equipment (UE) served by the first network node in a wireless communications network, wherein respective channel quality measurement resources are pre-allocated for each of one or more neighboring network nodes for transmitting respective signals of one or more long-term power levels, which long-term power levels are functions of instantaneous power levels of more than one time and frequency resource of a radio link, the method comprising:
configuring the UE to perform a channel quality measurement of the signals which are transmitted using the one or more long-term power levels by the one or more neighboring network nodes in the pre-allocated channel quality measurement resources,
receiving a report from the UE, which report reports a first Channel Quality Indicator (CQI), wherein the first CQI is calculated based on a channel quality measurement performed on the signals of the one or more long-term power levels according to the configuration, and
adapting the radio link for a transmission to the UE based on the received first CQI.

40. The method of claim 39, wherein the pre-allocated channel quality measurement resources comprise any one or more out of: Channel State Indicator—Interference Measurement (CSI-IM) resources, and CSI- Reference Signal (CSI-RS) resources.

41. The method of claim 39, wherein the one or more long-term power levels are functions of any one or more out of: an average traffic load level, a maximum traffic load level, and historic power levels, of the respective one or more neighboring network nodes.

42. The method of claim 39, wherein the one or more long-term power levels pre-allocated for each of one or more neighboring network nodes for the channel quality measurement resources comprises different levels of fixed power on different pre-allocated channel quality measurement resources.

43. The method of claim 39,
wherein the configuring the UE further comprises configuring the UE to perform one or more second channel quality measurements with any one or more out of:
fluctuating interference on CSI measurements resources, when the one or more neighboring network nodes transmit data to its respective served second UEs, and
full interference, when the one or more neighboring network nodes transmit always-on signals;
wherein the receiving of the report from the UE further reports one or more second CQIs, calculated based on the one or more second channel quality measurements; and
wherein the adapting the radio link for a transmission to the UE is further based on the received one or more second CQIs.

44. The method of claim 43, wherein the adapting the radio link for a transmission to the UE further based on the received one or more second CQIs comprises:
determining that the first CQI based on the channel quality measurement will be used for packets with a BLER requirement below the threshold, which channel quality measurements relate to a measurement with long-term interference,
determining that one of the one or more second CQI that is based on the second channel quality measurement with fluctuating interference will be used for packets with a BLER requirement equal to or above a threshold, and
determining that another one of the one or more second CQI being based on the second channel quality measurement with full interference will be used for packets with BLER requirement below a second threshold

45. A method performed by a second network node for assisting a first network node in adapting a radio link to a User Equipment (UE) served by the first network node in a wireless communications network, wherein respective channel quality measurement resources are pre-allocated for each of one or more neighboring network nodes, for transmitting respective signals of one or more long-term power levels, which long-term power levels are functions of instantaneous power levels of more than one time and frequency resource of a radio link, and wherein the one or more neighboring network nodes comprises the second network node, the method comprising:
transmitting signals of one or more long-term power levels in the pre-allocated channel quality measurement resources according to a configuration, which transmitted signals enable the first network node to adapting the radio link for a transmission to the UE.

46. The method of claim 45, wherein the transmitting of the signals of one or more long-term power levels in the pre-allocated channel quality measurement resources according to the configuration:
enables the UE to perform a channel quality measurement of the signals which are transmitted using the one or more long-term power levels by the one or more neighboring network nodes in the pre-allocated channel quality measurement resources, and
to calculate based on the channel quality measurement and report to the first network node, a first Channel Quality Indicator (CQI) to be used as a basis for adapting the radio link for a transmission to the UE,
which in turn enables the first network node to adapting the radio link for a transmission to the UE.

47. The method of claim 45, wherein the pre-allocated channel quality measurement resources comprise any one or more out of: Channel State Indicator—Interference Measurement (CSI-IM) resources, and CSI- Reference Signal (CSI-RS) resources.

48. The method of claim 45, wherein the one or more long-term power levels are functions of any one or more out of: an average traffic load level, a maximum traffic load level, and historic power levels, of the respective one or more neighboring network nodes.

49. The method of claim 45, wherein the one or more long-term power levels pre-allocated for each of one or more neighboring network nodes for the channel quality measurement resources comprises different levels of fixed power on different pre-allocated channel quality measurement resources.

50. A method performed by a User Equipment (UE) for assisting a first network node in adjusting a radio link between the first network node to the UE in a wireless communications network, wherein the UE is served by the first network node, wherein respective channel quality measurement resources are pre-allocated for each of one or more neighboring network nodes for transmitting respective signals of one or more long-term power levels, which long-term power levels are functions of instantaneous power levels of more than one time and frequency resource of a radio link, the method comprising:
receiving a configuration from the first network node, which configuration configures the UE to perform a channel quality measurement of the signals which are transmitted using the one or more long-term power levels by the one or more neighboring network nodes in the pre-allocated channel quality measurement resources,
performing a channel quality measurement on the signals according to the configuration,
calculating a first Channel Quality Indicator (CQI) based on the channel quality measurement performed on the signals of the one or more long-term power levels,
sending a report to the first network node, which report reports the calculated first CQI, enabling the first network node to adapt the radio link for a transmission, to the UE.

51. The method of claim 50, further comprising:
wherein the pre-allocated channel quality measurement resources comprise any one or more out of: Channel State Indicator—Interference Measurement (CSI-IM) resources, and CSI- Reference Signal (CSI-RS) resources.

52. The method of claim 50, wherein the one or more long-term power levels are functions of any one or more out of: an average traffic load level, a maximum traffic load level, and historic power levels, of the respective one or more neighboring network nodes.

53. The method of claim 50, wherein the one or more long-term power levels pre-allocated for each of one or more neighboring network nodes for the channel quality measurement resources comprises different levels of fixed power on different pre-allocated channel quality measurement resources.

54. The method of claim 50, wherein:
the received configuration further configures the UE to perform one or more second channel quality measurements with respective any one or more out of:
with fluctuating interference, when the one or more neighboring network nodes transmit data to its respective served second UEs, and
with full interference, when the one or more neighboring network nodes transmit always-on signals,
the performing further comprises performing the one or more second channel quality measurements according to the configuration,
the calculating further comprises calculating one or more second CQIs, based on the one or more second channel quality measurements, and
the report sent to the first network node further is reporting the calculated one or more second CQIs.

55. A first network node configured to adapt a radio link to a User Equipment (UE) served by the first network node in a wireless communications network, wherein respective channel quality measurement resources are arranged to be pre-allocated for each of one or more neighboring network nodes for transmitting respective signals of one or more long-term power levels, which long-term power levels are arranged to be functions of instantaneous power levels of more than one time and frequency resource of a radio link, the first network node comprising processing circuitry and input/output interface circuitry and the processing circuitry and input-output interface circuitry being configured to:
configure the UE to perform a channel quality measurement of signals which are transmitted using the one or more long-term power levels by the one or more neighboring network nodes in the pre-allocated channel quality measurement resources,
receive a report from the UE, which report is arranged to report a first Channel Quality Indicator (CQI), wherein the first CQI is to be calculated based on a channel quality measurement performed on the signals of the one or more long-term power levels according to the configuration, and
adapt the radio link for a transmission to the UE based on the first CQI.

56. The first network node of claim 55, wherein the pre-allocated channel quality measurement resources comprise any one or more out of: Channel State Indicator—Interference Measurement (CSI-IM) resources, and CSI- Reference Signal (CSI-RS) resources.

57. The first network node of claim 55, wherein the one or more long-term power levels are arranged to be functions of any one or more out of: an average traffic load level, a maximum traffic load level, and historic power levels, of the respective one or more neighboring network nodes.

58. The first network node of claim 55, wherein the one or more long-term power levels pre-allocated for each of one or more neighboring network nodes for the channel quality measurement resources is arranged to comprise different levels of fixed power on different pre-allocated channel quality measurement resources.

59. The first network node of claim 55, wherein the processing circuitry and input-output interface circuitry are further configured to;
configure the UE to further perform one or more second channel quality measurements with any one or more out of:
fluctuating interference, when the one or more neighboring network nodes transmit data to its respective served second UEs, and
full interference, when the one or more neighboring network nodes transmit always-on signals,
receive the report from the UE, which further is arranged to report one or more second CQIs, arranged to be calculated based on the one or more second channel quality measurements, and
adapt the radio link for a transmission to the UE further based on the one or more second CQIs.

60. The first network node of claim 59, wherein the processing circuitry and input-output interface circuitry are further configured to adapt the radio link for a transmission to the UE further based on the one or more second CQI by:
determining that the first CQI based on the channel quality measurement will be used for packets with a BLER requirement below the threshold, which channel quality measurements is arranged to relate to a measurement with long-term interference,
determining that one of the one or more second CQI that is based on the second channel quality measurement with fluctuating interference is arranged to be used for packets with a BLER requirement equal to or above a threshold, and
determining that another one of the one or more second CQI being based on the second channel quality measurement with full interference is arranged to be used for packets with a BLER requirement below a second threshold.
